(19) United States
(12) Patent Application Publication
(10) Pub. No.: US 2007/0110440 A1
(43) Pub. Date: May 17, 2007

(54) Measuring system and method for optical network

(75) Inventor: Heng-Yi Yang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/595,994

(22) Filed: Nov. 13, 2006

(30) Foreign Application Priority Data
Nov. 11, 2005 (TW) 094139635

(51) Int. Cl. H04J 14/00

(52) U.S. Cl. 398/70

(57) ABSTRACT

A measuring system for an optical network, which has a plurality of optical network units and an optical line terminal, includes a signal generator, a signal dividing device and a measuring device. The signal generator produces a data signal and a control signal, which is then delivered to the optical network units. The signal dividing device delivers the control signal to one of the optical network units at a first time, and then delivers the control signal to another optical network unit at the second time. The optical network unit delivers the data signal to the optical line terminal after receiving the control signal. The measuring device measures the data signal received by the optical line terminal.

### CROSS REFERENCE TO RELATED APPLICATIONS

This Non-provisional application claims priority under 35 U.S.C. 119(a) on Patent Application No(s). 094139635 filed in Taiwan, Republic of China on Nov. 11, 2005, the entire contents of which are hereby incorporated by reference.

### BACKGROUND OF THE INVENTION

1. Field of Invention

The invention relates to a measuring system and method. In particular, the invention relates to a measuring system and method for an optical network.

2. Related Art

With the rapid growth of the Internet, users have higher demands for transmission bandwidths. Therefore, a broadband optical network becomes one of the best solutions.

FIG. 1 shows a conventional optical network. Generally speaking, the optical network 1 is a passive optical network (PON) with a point-to-many-point (P2MP) structure. The optical network 1 has several optical network units (ONU) 11 and an optical line terminal (OLT) 12. The optical network 1 can adopt the time division multiple access (TDMA) scheme. Therefore, once the ONU's 11 of the optical network 1 are registered, each of them is assigned with a time slot for devoted signal transmissions. Each ONU 11 can send packets only in the devoted time slot to avoid data collisions.

Generally speaking, to test the optical network 1 (such as the error rate and sensitivity), a signal generator 13 is usually disposed at each ONU 11 to provide a control signal 131 and a data signal 132, which are simultaneously sent to the ONU's 11. The control signal 131 is used to control the ONU 11 to turn the data signal 132 into an optical signal 131′ to be transmitted to the OLT 12. A measuring device 14 is disposed at the OLT 12. After the OLT 12 receives the optical signal 131′ transmitted from the ONU's 11, the optical signal 131′ is converted into the corresponding electrical signal 131″. The measuring device 14 then measures the electrical signal 131″, thereby determining the sensitivity and error rate of the optical network 1. However, the above-mentioned measuring method requires several signal generators 13 in order to generate respective control signals 131 and data signals 132 for detection. Therefore, if the optical network 1 has 32 ONU's 11, 32 signal generators 13 are needed for the error detection of the optical network. However, the signal generator 13 is an expensive apparatus. This method thus increases the entire detection cost.

Therefore, it is an important subject of the invention to provide a simple measuring system and method for an optical network in order to reduce the measuring cost.

### SUMMARY OF THE INVENTION

In view of the foregoing, the invention is to provide a measuring system and method for an optical network for reducing the overall measuring cost.

To achieve the above, a measuring system for an optical network of the invention includes a signal generator, a signal dividing device, and a measuring device. The optical network has a plurality of ONU's and an OLT. The signal generator generates a data signal, which is delivered to the ONU's, and a control signal. The signal dividing device receives the control signal and delivers the control signal to one of the ONU's at a first time and to another ONU at a second time. The measuring device is electrically coupled to the OLT. After the ONU receives the control signal, it delivers the data signal to the OLT. The measuring device then measures the data signal received by the OLT.

To achieve the above, the invention also discloses a measuring method for an optical network, which has a plurality of ONU's and an OLT. The measuring method includes the steps of: providing a data signal to each of the ONU's, providing a control signal at a first time to one of the ONU's, which then delivers the data signal to the OLT, providing the control signal at a second time to another one of the ONU's, which then delivers the data signal to the OLT, and measuring the data signal received by the OLT.

As mentioned above, the measuring system and method for an optical network uses a signal dividing device to generate a control signal according to the data signal. The control signal is then delivered to one of the ONU's at different time slots. It controls one of the ONU's to deliver the data signal to the OLT, thereby simulating the TDMA transmissions. The data signal received by the OLT is measured in order to determine the error rate and sensitivity of the optical network. In comparison with the prior art, the disclosed measured system and method for an optical network only needs one signal generator to measure the optical network, thus reducing the cost of the entire measuring system.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional measuring system for an optical network;

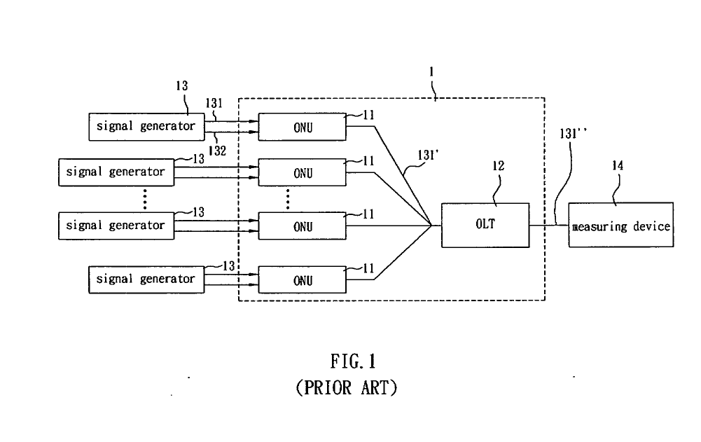

FIG. 2 is a schematic view of a measuring system for an optical network according to a preferred embodiment of the invention; and

FIG. 3 shows the waveforms of various signals from the signal dividing device of the measuring system for an optical network according to the embodiment of the invention.

### DETAILED DESCRIPTION OF THE INVENTION

The present invention will be apparent from the following detailed description, which proceeds with reference to the accompanying drawings, wherein the same references relate to the same elements.

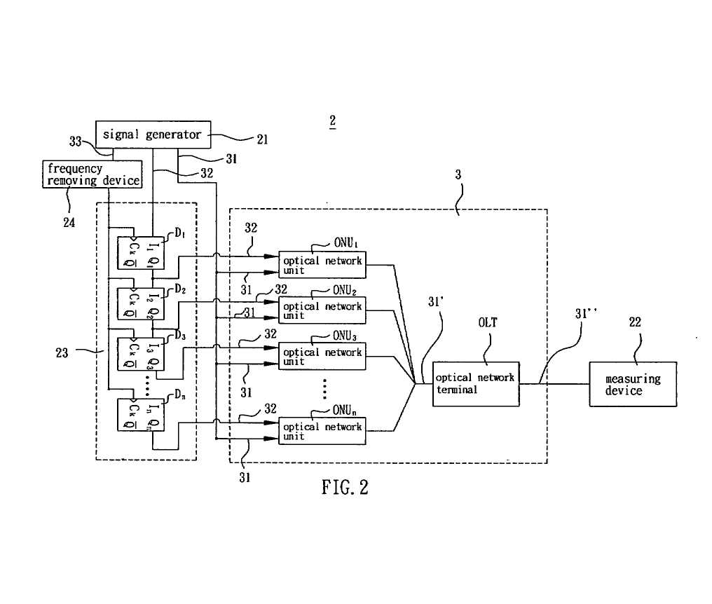

A preferred embodiment of a measuring system for an optical network is schematically shown in FIG. 2.

The optical network 3 is a passive optical network (PON) and has several optical network units (ONU) ONU₁.ONUₙ and an optical network terminal (OLT). The ONU's ONU₁.ONUₙ are connected to the OLT via several optical fibers of different lengths, thereby forming the optical network 3.

The measuring system 2 in this embodiment can be used to measure the sensitivity and error rate in the above-mentioned optical network 3. The measuring system 2 includes a signal generator 21, a measuring device 22, and a signal dividing device 23. The signal generator 21 is a pulse pattern generator (PPG) for generating a data signal 31, a control signal 32, and a pulse signal 33. The signal generator 21 is connected to the ONU's ONU₁.ONUₙ for providing the data signal 31 and the control signal 32 to the ONU's ONU₁.ONUₙ. The data signal 31 is for testing, whereas the control signal 32 is used to drive the ONU's ONU₁.ONUₙ. After the ONU's ONU₁. ONUₙ receive the control signal 32, the data signal 31 is converted into an optical signal 31′, and the optical signal 31′ is then delivered to the OLT via an optical fiber. Besides, after the OLT receives the optical signal 31′, it generates a corresponding electrical signal 31″.

The measuring device 22 is electrically coupled to the OLT for measuring the electrical signal 31″. The sensitivity and error rate of the optical network 3 are then determined according to the electrical signal 31″.

In this embodiment, the measuring device 22 is an error detector (ED). The measuring device 22 and the signal generator 21 are synchronized. The data signal 31 generated by the signal generator 21 is compared with the electrical signal 31″ to obtain the error rate and reception sensitivity of the optical network 3.

The signal dividing device 23 receives the control signal 32 and is coupled to the ONU's ONU₁.ONUₙ. The signal dividing device 23 is a shift register that can simulate TDMA. In different time slots, it provides the control signal 32 to one of the ONU's ONU₁.ONUₙ for controlling the ONU's ONU₁.ONUₙ to deliver the data signal 31 to the OLT for measurement. In this embodiment, the signal dividing device 23 has n flip-flops D₁.Dₙ.

The flip-flops D₁.Dₙ are D-type flip-flops, each of the flip-flops D₁.Dₙ has a signal input terminal (I₁.Iₙ), an output terminal (Q₁.Qₙ), and a trigger terminal (Cₖ). The number of the flip-flops D₁.Dₙ is determined by the number of the ONU's ONU₁. ONUₙ, so that the output terminals Q₁.Qₙ of the flip-flops D₁.Dₙ correspond to the ONU's ONU₁.ONUₙ; respectively.

The signal dividing device 23 of this embodiment has the following connections. The input terminal I₁ of the flip-flop D₁ is connected to the signal generator 21 for receiving the control signal 32. The output terminal Q₁ of the flip-flop D₁ is connected to the input terminal I₂ of the flip-flop D₂. The output terminal Q₂ of the flip-flop D₂ is connected to the input terminal 13 of the flip-flop D₃. This pattern continues until the output terminal Qₙ₋₁ of the flip-flop Dₙ₋₁ to the input terminal Iₙ of the flip-flop Dₙ. Moreover, the trigger terminals Cₖ of the flip-flops D₁. Dₙ are together coupled to the pulse signal 33 of the signal generator 21 to provide the trigger signals of the flip-flops D₁.Dₙ. Besides, ONU₁ is connected to the output terminal Q₁ of the flip-flop D₁, ONU₂ is connected to the output terminal Q₂ of the flip-flop D₂, ONU₃ is connected to the output terminal Q₃ of the flip-flop D₃, and so on.

Due to the properties of the D-type flip-flop, it can deliver the signal at its input terminal to its output terminal after receiving the trigger signal (positive-edge trigger or negative-edge trigger). Therefore, a shift register is formed when the D-type flip-flops are connected in series.

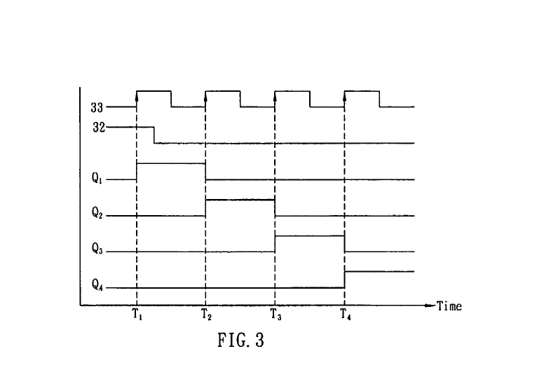

Please refer simultaneously to FIG. 3 for the pulse pattern of the output signal from the signal dividing device 23. For the convenience of illustration, the drawing only shows the output signals of the output terminals Q₁.Q₄. The actions of the signal dividing device 23 are described as follows. After the input terminal I₁ of the flip-flop D₁ receives the control signal 32 generated by the signal generator 21 (here the control signal 32 is assumed to be a high-level signal), the output terminal Q₁ of the flip-flop D₁ provides the control signal 32 at a first time T₁ to the ONU ONU₁. At a second time T₂; the output terminal Q₂ of the flip-flop D₂ provides the control signal 32 to the ONU ONU₂. At a third time T₃, the output terminal Q₃ of the flip-flop D₃ provides the control signal 32 to the ONU ONU₃. At a fourth time T₄, the output terminal Q₄ of the flip-flop D₄ provides the control signal 32 to the ONU ONU₄. The actions of other flip-flop D₅˜Dₙ are the same as those described above. At different time slots, the signal dividing device 23 provides the control signal 32 to one of the ONU's ONU₁˜ONUₙ in order to simulate the TDMA.

The measuring method of the disclosed measuring system 2 is as follows. First, the signal generator 21 generates a data signal 31 to the ONU's ONU₁.ONUₙ. Afterwards, the signal dividing device 23 provides the control signal 32 to the ONU ONU₁ at a first time T₁ for driving the ONU ONU₁ to deliver the data signal 31 to the OLT. At a second time T₂, the signal dividing device 23 provides the control signal 32 to the ONU ONU₂ for driving the ONU ONU₂ to deliver the data signal 31 to the OLT. At a third time T₃, the signal dividing device 23 provides the control signal 32 to the ONU ONU₃ for driving the ONU ONU₃ to deliver the data signal 31 to the OLT. This pattern continues so that the ONU's ONU₁.ONUₙ converts the data signal 31 at different time slots into an optical signal 31′ and delivers it to the OLT for achieving TDMA. The measuring device 22 further compares the electrical signal 31″ generated by the OLT and the data signal 31 generated by the signal generator 21, thereby obtaining the error rate of the optical network 3. Moreover, the measuring device 22 measures the power of the electrical signal 31″ to obtain the sensitivity of the optical network 3.

Besides, the measuring system 2 further includes a frequency removing device 24 disposed between the signal generator 21 and the signal dividing device 23. Since the frequency of the pulse signal 33 generated by the signal generator 21 may not comply with the desired frequency, the frequency removing device 24 then performs the frequency removal on the pulse signal 33. After the pulse signal 33 of the appropriate frequency is obtained, it is delivered to the signal dividing device 23 as the trigger signal of the flip-flops D₁.Dₙ.

In summary, the measuring system and method for an optical network uses a signal dividing device to generate a control signal according to the data signal. The control signal is then delivered to one of the ONU's at different time slots. It controls one of the ONU's to deliver the data signal to the OLT, thereby simulating the TDMA transmissions. The data signal received by the OLT is measured in order to determine the error rate and sensitivity of the optical network. In comparison with the prior art, the disclosed measured system and method for an optical network only needs one signal generator to measure the optical network, thus reducing the cost of the entire measuring system.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A measuring system for an optical network having a plurality of optical network units (ONU) and an optical line terminal (OLT), the measuring system comprising:
a signal generator for generating a data signal and a control signal and delivering the data signal to the optical network units;
a signal dividing device for receiving the control signal so as to deliver the control signal to one of the optical network units at a first time and deliver the control signal to another one of the optical network units at a second time; and
a measuring device electrically coupled to the optical line terminal, wherein after receiving the control signals, the optical network units delivers the data signal to the optical line terminal, and the measuring device measures the data signal received by the optical line terminal.

2. The measuring system of claim 1, wherein the signal generator is a pulse pattern generator (PPG).

3. The measuring system of claim 1, wherein the signal dividing device is a shift register.

4. The measuring system of claim 3, wherein the shift register has a plurality of flip-flops, and output terminals of the flip-flops correspond to the optical network units.

5. The measuring system of claim 4, wherein the flip-flops are D-type flip-flops.

6. The measuring system of claim 1, wherein the optical network is a passive optical network.

7. The measuring system of claim 1, wherein the measuring device is an error detector (ED).

8. The measuring system of claim 1, wherein the measuring device measures the data signal received by the optical line terminal for determining a sensitivity of the optical network.

9. The measuring system of claim 1, wherein the measuring device measures the data signal received by the optical line terminal for determining an error rate of the optical network.

10. The measuring system of claim 1, wherein the signal generator further generates a pulse signal to the signal dividing device.

11. The measuring system of claim 10, further comprising:
a frequency removing device connected between the signal generator and the signal dividing device for removing undesired frequencies in the pulse signal and delivering the pulse signal to the signal dividing device.

12. A measuring method for an optical network having a plurality of optical network units and an optical line terminal, the measuring method comprising the steps of:
providing a data signal to the optical network units;
providing a control signal at a first time to one of the optical network units, wherein the optical network unit then delivers the data signal to the optical line terminal;
providing the control signal at a second time to another one of the optical network units, wherein the optical network unit then delivers the data signal to the optical line terminal; and
measuring the data signal received by the optical line terminal.

13. The measuring method of claim 12, wherein the optical network is a passive optical network.

14. The measuring method of claim 12, wherein the data signal received by the optical line terminal is measured by an error detector (ED).

15. The measuring method of claim 12, wherein the step of measuring the data signal received by the optical line terminal further determines a sensitivity of the optical network according to the data signal.

16. The measuring method of claim 12, wherein the step of measuring the data signal received by the optical line terminal further determines an error rate of the optical network according to the data signal.

17. The measuring method of claim 12, wherein the control signal is provided by a shift register or a signal dividing device to the optical network units.

18. The measuring method of claim 17, wherein the shift register or the signal dividing device has a plurality of flip-flops.

19. The measuring method of claim 18, wherein the flip-flops are D-type flip-flops.
